(19) United States
(12) Patent Application Publication
(10) Pub. No.: US 2014/0131063 A1
(43) Pub. Date: May 15, 2014

(54) SPLIT LB10 CONDUIT

(71) Applicant: Jeremy Miller, Terra Alta, WV (US)

(72) Inventor: Jeremy Miller, Terra Alta, WV (US)

(21) Appl. No.: 13/674,441

(22) Filed: Nov. 12, 2012

(51) Int. Cl. H02G 3/04; H02G 1/00

(52) U.S. Cl. CPC H02G 3/0462; H02G 1/00
USPC 174/95; 29/825

(57) ABSTRACT

A split LB 10 conduit that includes a base LB 10 conduit that includes a top half, a bottom half, a horizontal orifice and a vertical orifice, the base LB 10 conduit is split open into the top half and the bottom half and a plurality of electrical wires that are placed within the top half and the bottom half of the base LB 10 conduit, the electrical wires are sealed between the top half and the bottom half of the base LB 10 conduit, the electrical wires are sealed with a plurality of removable threaded screws that are extended through a plurality of threaded apertures. The split LB 10 conduit also includes a method for installing a plurality of electrical wires with a split LB 10 conduit.

### TECHNICAL FIELD & BACKGROUND

Many people in the construction field use LB 10 conduit for wiring purposes during a project. It can be difficult and time consuming to run relatively long lengths of wire through a small L-shaped fixture such as a LB 10 conduit.

The present invention generally relates to a conduit. More specifically, the invention is a LB 10 conduit.

It is an object of the invention to provide a LB 10 conduit that is split lengthwise to install electrical wires relatively easier, faster and more efficiently than with a traditional LB 10 conduit.

It is an object of the invention to provide a LB 10 conduit that is split lengthwise in two halves to allow a user to place a plurality of electrical wires between the two halves in contrast to running the electrical wires through a one piece LB 10 conduit.

It is an object of the invention to provide a method for installing a plurality of electrical wires with a split LB 10 conduit.

What is really needed is a piece of LB 10 conduit that is split lengthwise to install electrical wires relatively easier, faster and more efficiently than with a traditional LB 10 conduit to allow a user to place a plurality of electrical wires between the two halves in contrast to running the electrical wires through a one piece LB 10 conduit and a method for installing a plurality of electrical wires with a split LB 10 conduit.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a split LB 10 conduit, according to an embodiment of the present invention.

FIG. 2 illustrates a flowchart of a method for installing a plurality of electrical wires with a split LB 10 conduit, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

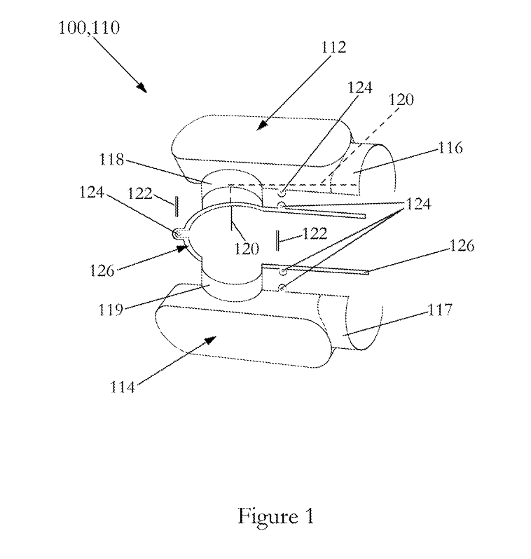

FIG. 1 illustrates a side view of a split LB 10 conduit 100, according to an embodiment of the present invention. The split LB 10 conduit 100 includes a base LB 10 conduit 110 and a plurality of electrical wires 120. The split LB 10 conduit 100 is typically made of plastic but can be made of metal such as aluminum or any other suitable material. The base LB 10 conduit 110 includes a top half 112, a bottom half 114, a top horizontal orifice half 116, a bottom horizontal orifice half 117, a top vertical orifice half 118 and a bottom vertical orifice half 119. The base LB 10 conduit 110 is split open into the top half 112 and the bottom half 114. The electrical wires 120 are placed within the top half 112 and the bottom half 114 and are then sealed with the electrical wires 120 between the top half 112 and the bottom half 114. The electrical wires 120 are sealed with a plurality of removable threaded screws 122 or other suitable fasteners that are extended through a plurality of threaded apertures 124 disposed on the top half 112 of the base LB 10 conduit 110 to secure a seal 126 also disposed on the top half 112 of the base LB 10 conduit 110. This is in contrast to use of a traditional LB 10 conduit (not shown) where the electrical wires (not shown) are run through a one piece traditional LB 10 conduit and its horizontal orifice and the vertical orifice (not shown) typically by hand or other suitable methodology. The electrical wires can be as long as approximately 100 feet in length for relatively larger projects.

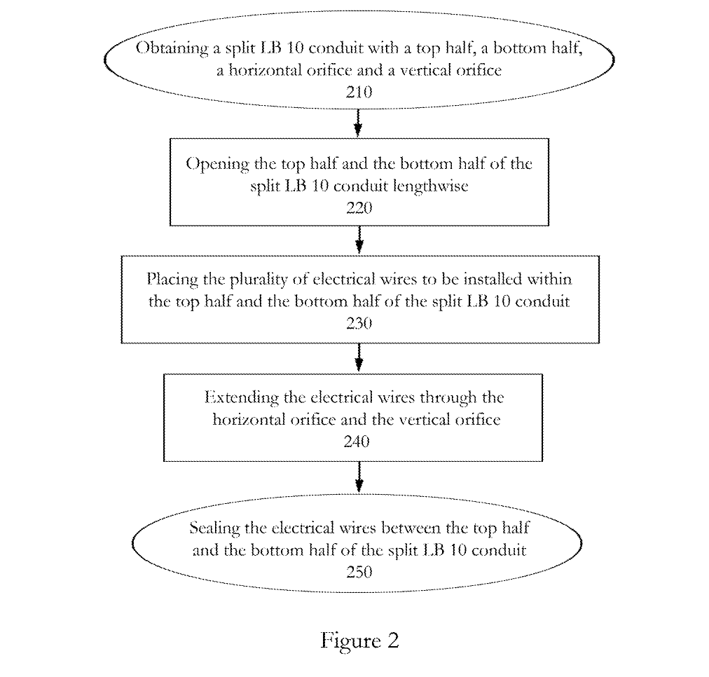

FIG. 2 illustrates a flowchart of a method 200 for installing a plurality of electrical wires with a split LB 10 conduit, according to an embodiment of the present invention.

The method 200 for installing a plurality of electrical wires with a split LB 10 conduit includes the steps of obtaining a split LB 10 conduit with a top half, a bottom half, a horizontal orifice and a vertical orifice 210, opening the top half and the bottom half of the split LB 10 conduit lengthwise 220, placing a plurality of electrical wires to be installed within the top half and the bottom half of the split LB 10 conduit 230, extending the electrical wires through the horizontal orifice and the vertical orifice 240 and sealing the electrical wires between the top half and the bottom half of the split LB 10 conduit 250.

The obtaining a split LB 10 conduit with a top half, a bottom half, a horizontal orifice and a vertical orifice 210 step can be from a suitable provider of the split LB 10 conduit. The split LB 10 conduit is typically provided by a hardware store that sells the split LB 10 conduit or other suitable source of split LB 10 conduit such as ordering the split LB 10 conduit over the Internet from a split conduit manufacturer or distributor. The opening the top half and the bottom half of the split LB 10 conduit lengthwise 220 step includes splitting the split LB 10 conduit open exposing the top half and the bottom half of the split LB 10 conduit. The placing a plurality of electrical wires to be installed within the top half and the bottom half of the split LB 10 conduit 230 step includes placing any suitable type of electrical wires to be installed within the top half and the bottom half of the split LB 10 conduit. The extending the electrical wires through the horizontal orifice and the vertical orifice 240 step is performed while the top half and the bottom half of the split LB 10 conduit is still split open. The sealing the electrical wires between the top half and the bottom half of the split LB 10 conduit 250 step includes sealing the electrical wires with a plurality of removable threaded screws that are extended through a plurality of threaded apertures disposed on the top half of the base LB 10 conduit to secure a seal disposed on the top half of the base LB 10 conduit.

The split base LB 10 conduit may be used when installing a variety of different types of electrical wires. The split base LB 10 conduit is made of plastic with a plurality of screws and a seal and can be split lengthwise and is resealed once the electrical wires are laid into the split base LB 10 conduit but can be made of other materials such as metal, aluminum or other suitable material. The size and shape of the base LB 10 conduit is determined by the size and angle of the electrical wires. The split base LB 10 conduit may be readily available at hardware retailers and other suitable hardware sources. The split base LB 10 conduit is typically utilized for electrical construction jobs but can be utilized for other suitable types of jobs. The split base LB 10 conduit is designed to be available to accommodate a variety of shapes and sizes of electrical wires.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A split LB 10 conduit, comprising:
a base LB 10 conduit that includes a top half, a bottom half, a horizontal orifice and a vertical orifice, the base LB 10 conduit is split open into the top half and the bottom half; and
a plurality of electrical wires that are placed within the top half and the bottom half of the base LB 10 conduit, the electrical wires are sealed between the top half and the bottom half of the base LB 10 conduit.

2. The split LB 10 conduit according to claim 1, wherein the electrical wires are sealed with a plurality of removable threaded screws that are extended through a plurality of threaded apertures.

3. The split LB 10 conduit according to claim 2, wherein the threaded apertures are disposed on the top half of the base LB 10 conduit.

4. The split LB 10 conduit according to claim 2, wherein the removable threaded screws secure a seal.

5. The split LB 10 conduit according to claim 4, wherein the seal is disposed on the top half of the base LB 10 conduit.

6. The split LB 10 conduit according to claim 1, wherein the split LB 10 conduit is made of plastic.

7. A split LB 10 conduit, comprising:
a base LB 10 conduit that includes a top half, a bottom half, a horizontal orifice and a vertical orifice, the base LB 10 conduit is split open into the top half and the bottom half; and
a plurality of electrical wires that are placed within the top half and the bottom half of the base LB 10 conduit, the electrical wires are sealed between the top half and the bottom half of the base LB 10 conduit, the electrical wires are sealed with a plurality of removable threaded screws that are extended through a plurality of threaded apertures.

8. The split LB 10 conduit according to claim 7, wherein the threaded apertures are disposed on the top half of the base LB 10 conduit.

9. The split LB 10 conduit according to claim 7, wherein the removable threaded screws secure a seal.

10. The split LB 10 conduit according to claim 9, wherein the seal is secured on the top half of the base LB 10 conduit.

11. The split LB 10 conduit according to claim 7, wherein the split LB 10 conduit is made of plastic.

12. The split LB 10 conduit according to claim 7, wherein the split LB 10 conduit is made of metal.

13. The split LB 10 conduit according to claim 12, wherein the split LB 10 conduit is made of aluminum.

14. A method for installing a plurality of electrical wires with a split LB 10 conduit comprising the steps of:
obtaining a split LB 10 conduit with a top half, a bottom half, a horizontal orifice and a vertical orifice;
opening the top half and the bottom half of the split LB 10 conduit lengthwise;
placing the plurality of electrical wires to be installed within the top half and the bottom half of the split LB 10 conduit;
extending the electrical wires through the horizontal orifice and the vertical orifice; and
sealing the electrical wires between the top half and the bottom half of the split LB 10 conduit.

15. The method according to claim 14, wherein the obtaining a split LB 10 conduit with a top half, a bottom half, a horizontal orifice and a vertical orifice step is from a hardware store that sells the split LB 10 conduit.

16. The method according to claim 14, wherein the obtaining a split LB 10 conduit with a top half, a bottom half, a horizontal orifice and a vertical orifice step is from a split conduit manufacturer that sells the split LB 10 conduit over the Internet.

17. The method according to claim 14, wherein the extending the electrical wires through the horizontal orifice and the vertical orifice step is performed while the top half and the bottom half of the split LB 10 conduit is split open.

18. The method according to claim 14, wherein the sealing the electrical wires between the top half and the bottom half of the split LB 10 conduit step includes sealing the electrical wires with a plurality of removable threaded screws.

19. The method according to claim 18, wherein the removable threaded screws are extended through a plurality of threaded apertures disposed on the top half of the base LB 10 conduit.

20. The method according to claim 19, wherein the removable threaded screws secure a seal disposed on the top half of the base LB 10 conduit.
